(19) United States
(12) Patent Application Publication
(10) Pub. No.: US 2015/0339441 A1
(43) Pub. Date: Nov. 26, 2015

(54) SYSTEMS AND METHODS FOR ATTACHING ELECTRONIC VERSIONS OF PAPER DOCUMENTS TO ASSOCIATED PATIENT RECORDS IN ELECTRONIC HEALTH RECORDS

(71) Applicant: Xerox Corporation, Norwalk, CT (US)

(72) Inventor: Barry Glynn Gombert, Rochester, NY (US)

(73) Assignee: Xerox Corporation, Norwalk, CT (US)

(21) Appl. No.: 14/284,622

(22) Filed: May 22, 2014

(51) Int. Cl. G06F 19/00

(52) U.S. Cl. CPC G06F 19/322

(57) ABSTRACT

A system and method for automated entry of electronic versions of paper documents into corresponding patient records in an Electronic Health Record (EHR) is provided. A natural language parsing component extracts named entity information from electronic versions of patient-related paper documents and determines the EHR patients which correspond to the electronic versions. The electronic versions are classified by medical procedure and matched with EHR patient orders obtained from querying the EHR. The electronic versions with are matched to EHR patient orders are entered into the EHR and notifications for the electronic versions which are not matched are generated.

### BACKGROUND

The exemplary embodiment relates to the association of medical data with corresponding patients and finds particular application in connection with a system and method which use natural language parsing to automatically extract patient identity information from the medical data and determine the patients to which it corresponds for association into the patients' health records.

Electronic medical records (EMR), also referred to as electronic health records (EHR), is an evolving concept defined as a systematic collection of electronic health information about individual patients or populations. EHR are computerized medical records that are often created in an organization that delivers care, such as a hospital or physician's office. These records, stored in digital format, are capable of being shared across different health care settings. In some cases this sharing can occur by way of network-connected, enterprise-wide information systems and other information networks or exchanges. Different sources of medical information can be shared and/or aggregated over such a health care network.

EHRs contain a historical base of information about a patient's interaction with a healthcare provider. In some systems such as OpenMRS each and every interaction that a patient has with a provider is captured in the form of an encounter. An encounter is an electronic form completed for a patient and has an encounter type, date/time, location, and provider specific information. Within an encounter, different observations, and orders are recorded. Over time this provides a rich base of information that can be accessed to obtain information about a patient and their history of care.

The EHR may include a range of data, including medical history, current and past medications and allergies, immunizations, laboratory test results, radiology images, vital signs, personal statistics, such as age and weight, and the like. For purposes herein, both EMR and EHR are considered to be EHR unless otherwise noted. A personal health record (PHR) is a patient-specific EHR, relating to a single person.

The system is designed to capture and re-present data that accurately capture the state of the patient at all times. It allows for an entire patient history to be viewed without the need to track down the patient's previous medical record volume and assists in ensuring data is accurate, appropriate and legible. It reduces the chances of data replication as there is only one modifiable file, which means the file is constantly up to date when viewed at a later date and eliminates the issue of lost forms or paperwork. Due to all the information being in a single file, it makes it much more effective when extracting medical data for the examination of possible trends and long term changes in the patient.

Increases in storage and computing power have greatly improved the quality and quantity of medical data collected. Records of even a single patient may occupy several gigabytes of data, and the EHR can contain information for thousands of patients. Thus, the sheer size of this database provides challenges when updating the records of any particular patient. Entering new records or updating existing records with newly available data has required some hands-on/eyes-on handling of paper documents containing the new information. Typically, a person will read the paper document, or a portion of it, to acquire information about the patient which is then used to enter the data from the paper document into the EHR. This process is inefficient and time consuming. There exists a need for automating the entry of new data into the EHR.

### BRIEF DESCRIPTION

In accordance with one aspect of the exemplary embodiment, a system for method for entering electronic versions of paper documents into corresponding patient records in an Electronic Health Record (EHR) is provided. The method includes a computer processor extracting named entity information including patient identifiers and associated patient identity information from electronic versions of patient-related paper documents using natural language parsing; and determining EHR patients which correspond to the electronic versions using the patient identifiers. The method further includes classifying the electronic versions by medical procedure, associating order-matching criteria with the electronic versions in accordance with the classifying, querying the EHR to obtain orders of medical services for the EHR patients, and establishing matched electronic versions which correspond to EHR patient orders by comparing one or more orders obtained from the querying with the order-matching criteria. The method also includes entering the matched electronic versions into the EHR by forming an association in the EHR between the matched electronic versions and the EHR patients having at least one order matched in the matching operation, and generating notifications indicating at least one of the electronic versions entered into the EHR (i.e. matched electronic versions) and the electronic versions not entered into the EHR (i.e. unmatched electronic versions).

In accordance with another aspect of the exemplary embodiment, a system for entering electronic versions of paper documents into corresponding patient records in an EHR is provided. The system includes a natural language parsing component which extracts named entity information from electronic versions of patient-related paper documents and determines patient identifiers and associated patient identity information in the electronic versions using the named entity information and determines EHR patients which correspond to the electronic versions using the patient identifiers, the EHR patients having patient records in the EHR. The system also includes a classification component which classifies the electronic versions by medical procedure and associates order-matching criteria with the electronic versions in accordance with the classifying and a communication component for querying the EHR for orders of medical services for the EHR patients. The system also includes a matching component which establishes matched electronic versions that correspond to EHR patient orders by comparing one or more orders obtained from the querying with the order-matching criteria and an association component which enters the matched electronic versions into the EHR by forming an association in the EHR between the matched electronic versions and the EHR patients having at least one order matched in the matching operation. A notification component generates notifications indicating at least one of the electronic versions entered into the EHR (i.e. the matched electronic versions) and the electronic versions not entered into the EHR (i.e. the unmatched electronic versions). One or more processors implement the natural language parsing component, the classification component, the communication component, the association component, and the notification component.

### BRIEF DESCRIPTION OF THE DRAWINGS

FIG. 1 is a block diagram of a system for entering electronic versions of patient-related paper documents into corresponding patient records in an EHR;

FIG. 2 is a functional block diagram of the system illustrated in FIG. 1; and

FIG. 3 is a flow chart illustrating a method for entering electronic versions of patient-related paper documents into corresponding patient records in an EHR.

### DETAILED DESCRIPTION

An exemplary system and method for entering electronic versions of paper documents into corresponding patient records in an Electronic Health Record (EHR) is described herein.

As used herein, a healthcare provider can be any person involved with the use of a patient's electronic health record (EHR), such as a medical doctor, doctor's assistant, nurse, physiotherapist, radiologist, anesthesiologist, medical practice, or the like. A patient can be any person (or animal) for whom health records are generated.

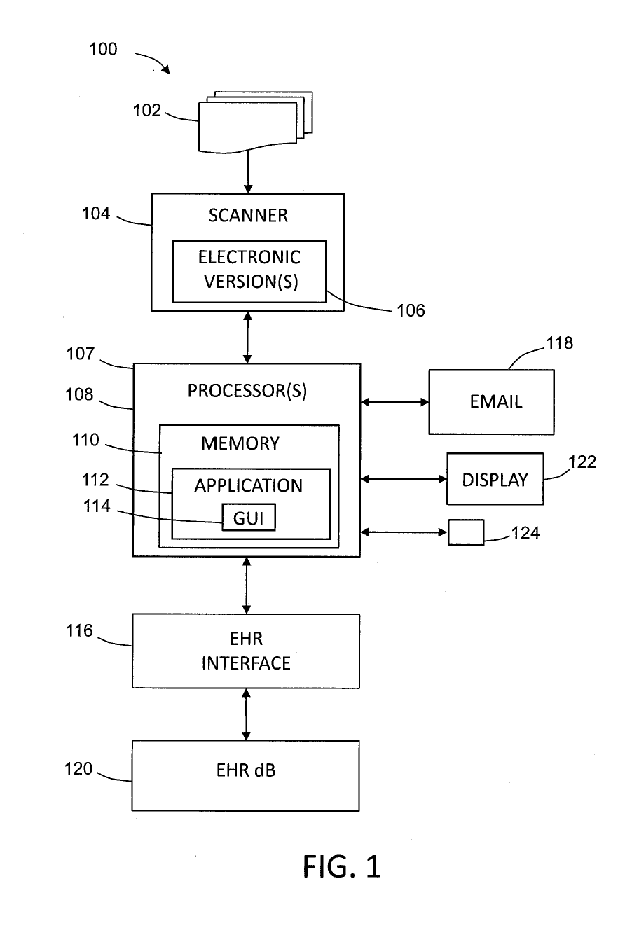

FIG. 1 illustrates one embodiment of an exemplary system 100 for entering electronic versions of paper documents 102 into corresponding patient records in the EHR which may be stored in one or more non-transitory data storage devices, such as the illustrated EHR database 120. The EHR dB 120, referred to herein as the EHR, can include a plurality of databases in a plurality of different platforms which can be accessed in any suitable known manner. It is assumed that any security and privacy issues are addressed. The system 100 enables the automatic association of an electronic version of a patient-related document with the patient and automatic entry of the electronic version into the EHR 120 in association with the patient.

The system 100 includes an electronic scanning device, also referred to as a scanner 104. The patient-related paper documents 102 are scanned in the scanner 104 to generate scanned data, referred to herein as the electronic versions of the paper documents 106. The one or more electronic version(s) are thus replications of the content of the one or more paper document(s). The paper documents 102 can be scanned in a different location, and/or by different entity than the entity which is tasked with entering the paper documents into the EHR 120. For example, a large collection of paper documents can be bulk scanned to form the electronic versions 106.

The system 100 includes a computing device 107 having a computer processor 108 in communication with memory 110. The memory 110 stores software instructions forming the Application 112 written for accomplishing the process described herein and the computer processor 108 executes the instructions for performing the automatic processes described herein. The Application 112 can include a plurality of computer Applications, each performing specific portions of automatic processes under the control of a master Application.

The computing device 107 can include more than one computing devices having one or more processor(s) 108, each performing portions of the operation and communicating with each other in any suitable known manner. e.g., via a wired or wireless network such as the Internet. The computer device 107 may be a server computer, a desktop, laptop, tablet, or palmtop computer, a portable digital assistant (PDA), a cellular telephone, a pager, combination thereof, or other computing device capable of executing instructions for performing the exemplary method.

The memory 110 may represent any type of non-transitory computer readable medium such as random access memory (RAM), read only memory (ROM), magnetic disk or tape, optical disk, flash memory, or holographic memory. In one embodiment, the memory 110 comprises a combination of random access memory and read only memory. In some embodiments, the processor 108 and memory 110 may be combined in a single chip.

The computing device 107 communicate with other devices via a computer network 130, such as a local area network (LAN) or wide area network (WAN), or the Internet, and may comprise a modulator/demodulator (MODEM) a router, a cable, and and/or Ethernet port. Memory 110 stores instructions for performing the exemplary method as well as acquired electronic versions 106 which can be transmitted to the computing device 107 from a remote location in a known manner.

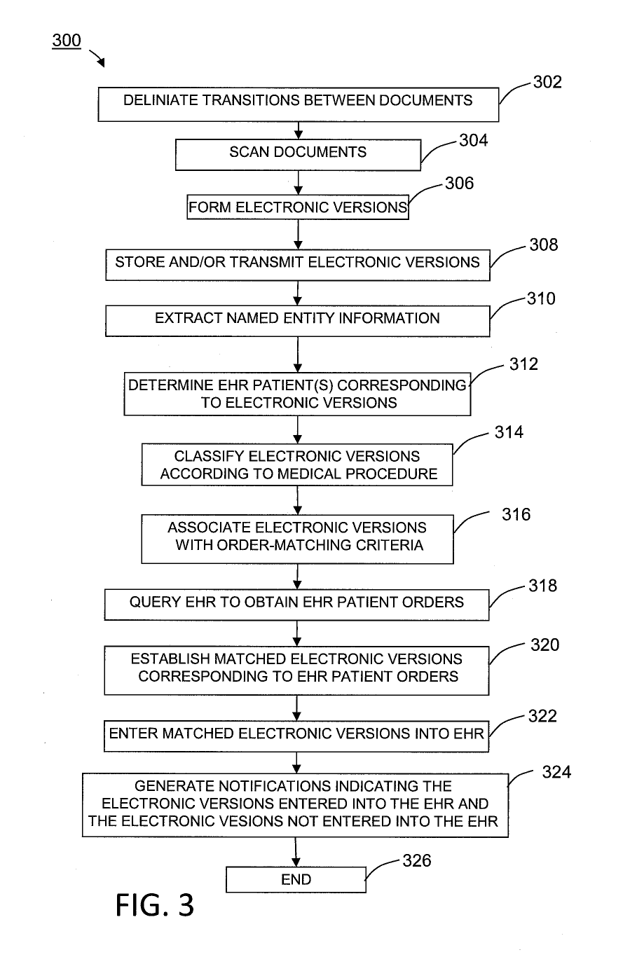

The computer processor 108 can be variously embodied, such as by a single-core processor, a dual-core processor (or more generally by a multiple-core processor), a digital processor and cooperating math coprocessor, a digital controller, or the like. The exemplary computer processor 108, in addition to controlling the operation of the computing device 107, executes instructions stored in memory 110 forming the Application 112 for performing the method outlined in FIG. 3.

As will be appreciated, FIG. 1 is a high level functional block diagram of only a portion of the components which are incorporated into a computer system. Since the configuration and operation of programmable computers are well known, they will not be described further.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The Application 112 can include a graphical user interface (GUI) 114 which may be hosted by the processor 108, enables user operation of the Application. The GUI 114 may be displayed to a healthcare provider on a display device 122, such as an LCD screen, computer monitor, or the like, which may be communicatively linked to or integral with the computing computer processor 108. The GU 114 may further include a user input device 124, such as a cursor control device, touch screen, keyboard, keypad or the like which allows the healthcare pro- vider to interact with the Application 112.

The 100 system can include an EHR interface 116 providing interfacing and communication with the EHR 120. The EHR interface can be a commercially available software and/or hardware made available to users for performing this purpose.

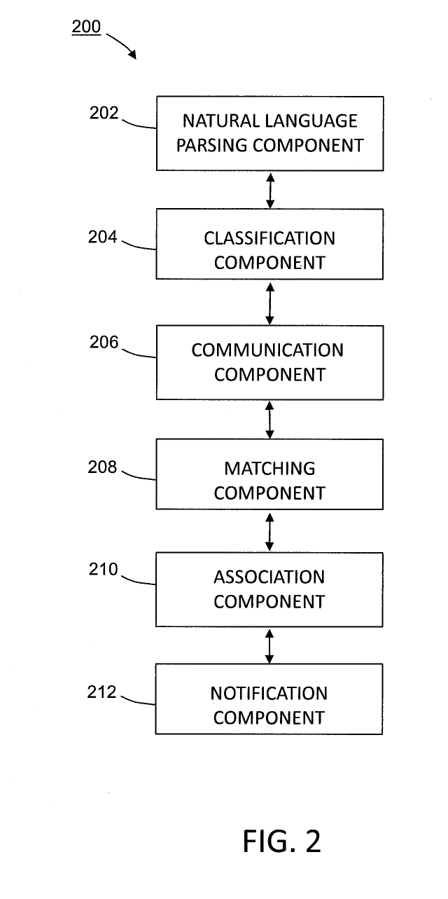

Referring now to FIG. 2, the exemplary Application 112 run by the processor 108 includes a natural language parsing component 202, which extracts named entity information from electronic versions of patient-related paper documents and determines patient identifiers and associated patient identity information in the electronic versions using the named entity information. The natural language parsing component 202 determines EHR patients which correspond to the electronic versions using the patient identifier. The EHR patients have patient records in the EHR 120. The processor 108 implements the natural language parsing component 202.

The Application 112 also includes a classification component 204 which classifies the electronic versions 106 by medical procedure and associates order-matching criteria with the electronic versions in accordance with the classifying.

The Application 112 also includes a communication component 206 for querying the EHR for orders of medical services for the EHR patients, as described in further detail below.

The Application 112 also includes a matching component 208 which establishes matched electronic versions that correspond to EHR patient orders by comparing one or more orders obtained from the querying with the order-matching criteria.

The Application 112 also includes an association component 210 which enters the matched electronic versions into the EHR by forming an association in the EHR between the matched electronic versions and the EHR patients having at least one order matched in the matching operation.

The Application 112 also includes a notification component 212 which generates notifications indicating at least one of the electronic versions entered into the EHR and the electronic versions not entered into the EHR. The notifications can be emails generated automatically using the Email system 118 as described in further detail below.

FIG. 3 illustrates a method shown generally at 300 for entering electronic versions 106 of patient-related paper documents 102 into corresponding patient records in an EHR 120, which may be performed with the system 100 of FIG. 1. The paper documents 102 are patient-related in that they relate to patients. Examples can include, but are not limited to, test results, lab reports, referrals, medical history information, current and past medications, allergies, immunizations, radiology images or reports, vital signs, and the like. The paper documents 102 referred to herein can be considered to be patient-related paper documents unless explicitly stated otherwise.

The patient-related paper documents 102 are scanned in the scanner 104 at 304 to generate the electronic versions of the paper documents 106. The electronic versions 106 are thus replications of the paper documents 102 stored in electronic form.

The paper documents 102 can be scanned in a different location, and/or by different entity than that which is tasked with entering the paper documents into the EHR 120. For example, a large collection of paper documents can be bulk scanned to form the electronic versions. Separating indicia can be used to delineate transitions between different patient-related paper documents prior to the scan at 302 in order to separate the electronic versions of the different paper document records. Examples of these separating indicia can include, but are not limited to special characters or marks which can be recognized as separating indicia, or use of a blank page or a page of a particular color, etc.

Optical character recognition (OCR) is the electronic conversion of scanned images of handwritten, typewritten or printed text into machine-encoded text. It is a common method of digitizing printed texts so that they can be electronically searched, stored in memory devices, transferred electronically, and used in various machine processes.

Intelligent character recognition ICR (ICR) is an advancement of (OCR) used for handwriting recognition. ICR that allows fonts and different styles of handwriting to be learned by a computer during processing to improve accuracy and recognition levels. ICR software can include a self-learning system, It extends the usefulness of scanning devices for the purpose of document processing, from printed character recognition (a function of OCR) to hand-written matter recognition. Accuracy rates in reading handwriting in structured forms can be very high.

A computer processor 108 uses OCR and/or ICR to form the electronic versions 106 at 306, either as part of the scanning step 302, or by post processing the scanned data. The bulk scan represented by the electronic versions 106 can then be stored and/or transmitted to a different location and/or entity at 308 which are obtained for entry into the EHR 120 in the manner described below.

The method of entering the patient data from the electronic versions 300 includes extracting named entity information from the electronic versions at 310. The named entity information includes patient identifiers, such as patient name, social security number, patient id number, etc. The named entity information also includes associated patient identity information such as sex, age, mailing address and other types of patient information which can be used to identify a specific patient in a manner described below. The named entity information also includes names of entities, organizations, physicians, laboratories, medical facilities, etc. which are contained in the electronic versions of the patient-related paper documents for use in classifying the electronic versions as described in further detail below. The named entity information can also include expressions of time, quantities, monetary values, percentages, and geographic locations.

The computer processor 108 extracts the named entity information using a natural language parsing component 202 that utilizes natural language parsing also referred to as a natural language parsing (NLP). NPL is a method of processing text in electronic form which enables computers to extract meaning from the words and phrases that people use. NLP language technologies convert human language into formal semantic representations which computer applications can interpret and act on. NLP processing can analyze underlying linguistic structures and relationships, grammatical rules, explicit concepts, implicit meanings, logic, discourse context, and more to provide accurate entity identification and extraction. The natural language parsing component 202 uses NLP to extract the named entity information and recognize this information for use in determining EHR patients which correspond to the electronic versions and for classifying the electronic versions by medical procedure as described in further detail below.

An exemplary natural language parser is the Xerox Incremental Parser (XIP) which is described, for example, in U.S. Pat. No. 7,058,567, issued Jun. 6, 2006, entitled NATURAL LANGUAGE PARSER, by Aït-Mokhtar, et al.; Aït-Mokhtar, S., Chanod, J-P., Roux, C. “Robustness beyond Shallowness: Incremental Deep Parsing”. Natural Language Engineering 8 (2002) 121-144. Similar incremental parsers are described in Aït-Mokhtar “Incremental Finite-State Parsing,” in Proc. 5th Conf. on Applied Natural language parsing (ANLP'97), pp. 72-79 (1997), and Aït-Mokhtar, et al., “Subject and Object Dependency Extraction Using Finite-State Transducers,” in Proc. 35th Conf. of the Association for Computational Linguistics (ACL'97) Workshop on Information Extraction and the Building of Lexical Semantic Resources for NLP Applications, pp. 71-77 (1997). The syntactic analysis performed by the parser may include the construction of a set of syntactic relations (dependencies) from an input text by application of a set of parser rules. Exemplary methods are developed from dependency grammars, as described, for example, in Mel'\check{c}uk I., “Dependency Syntax,” State University of New York, Albany (1988) and in Tesnière L., “Elements de Syntaxe Structurale” (1959) Klincksiek Eds. (Corrected edition, Paris 1969).

A specific application of the XIP parser to the medical field, which may be utilized herein, is described in Hagège C., Marchal P., Darmoni S. J., Gicquel Q., Pereira S., Metzger M-H, “Linguistic and Temporal Processing for Discovering Hospital Acquired Infection from Patient Records,” Proc. Knowledge Representation for Health-Care (KR4HC), ECAI 2010, Lisbon, Portugal, August 2010, Lecture Notes in Computer Science, Volume 6512, Pages 70-84, Springer Berlin/Heidelberg, 2011. (Hereinafter, Hagège 2010) and in “Assistant de Lutte Automatisèe et de Dètection des Infections Nosocomialles a partir de Documents textuels Hospitaliers (ALADIN-DTH), Development of an automated assistant to monitor Hospital Acquired Infections and A Detection System for Hospital Acquired Infections from Patient Discharge Summaries, at http://www.aladin-project.eu/index-en.html) hereinafter “ALADIN-DTH.” These last two references provide methods for extraction of named entities, particularly medical terms, which can be compared with the concepts to determine if there is a match.

The computer processor 108 uses the extracted named identity information to determine patients having patient records in the EHR which correspond to the electronic versions. Specifically, the natural language parsing component 202 uses the extracted named identity information to determine at 312 the identity of the person who corresponds to each electronic version, the correspondence being that the person or persons has the highest likelihood of being the patient to whom the electronic version of the patient-related paper document relates to. The majority of these patients have patient records in the EHR 120. This fact is corroborated when querying the EHR in a later step.

The goal of determining the EHR patients which correspond to the electronic versions is minimizing the number of EHR patients having highest correspondence with the electronic versions. However, initially, more than one EHR patient may be found to correspond to a particular electronic version. The number can be minimized, with the goal being finding a single individual EHR patient corresponding to each electronic version by using more named entity information. This may require further processing by the natural language parsing component if needed.

The classification component 204 then classifies the electronic versions 106 by the medical procedure to which they pertain at 314. This step can be performed by the computer processor 108 using the named entity information extracted by the natural language parsing component 200. The classification component 204 determines the medical procedure that corresponds to the electronic version and classifies the electronic version by this medical procedure.

Any suitable known medical taxonomy can be used to classify the electronic version by medical procedure. In the US, medical billing codes, such as CPT (Current Procedural Terminology) codes, developed by the AMA (American Medical Association), and/or Medicare codes may be used. These are numbers assigned to every task and service a medical practitioner may provide to a patient including medical, surgical and diagnostic services. In France, a classification referred to as “codage des actes mèdicaux,” which is used by the Social Security for reimbursement purposes may be used.

The classification component 204 then associates the electronic versions 106 with order-matching criteria for determining the outstanding or unfulfilled order relating to the medical procedure to which the electronic version pertains at 316. For example, the electronic versions which have been classified in accordance with the classification of the coded medical procedure(s) described above are associated with order-matching criteria for determining outstanding or unfulfilled orders relating to the medical procedure which has been performed by a medical professional over a preceding period, such as the past few months or years. The order matching criteria can include, but are not limited to, the name of the medical procedure, one or more tests relating to the medical procedure, the date of the medical procedure, originating source information for the source of the order, such as a person's name or an organization's name that ordered the medical procedure, an address, a provider's name, and contact information of the originating source, and the person or entity performing the medical procedure.

The communication component 206 then builds a query for querying the EHR 120 to obtain orders of medical services for the EHR patients determined at 312 as describe above. The query requests the orders made for medical services for the EHR patients from the EHR. The query can be made using any suitable protocol for communicating with the EHR via the EHR interface 116 to form a request for the orders made relating to the EHR patients. The communication component 206 transmits the query at 318 using the EHR interface 116 and receives the query results when the EHR 120 complies with the query request.

The matching component 208 then establishes matched electronic versions which correspond to EHR patient orders by comparing one or more orders obtained from the querying with the order-matching criteria at 320. Each matched electronic version has a corresponding EHR patient order as determined when one or more orders matches the order matching criteria.

The association component 210 enters the matched electronic versions into the EHR 120 at 322 by forming an association in the EHR between the matched electronic versions 106 and the EHR patients having at least one order matched in the matching operation.

The notification component 212 generates notifications at 324 indicating at least one of the electronic versions (i.e. the matched electronic versions) that were entered into the EHR and the electronic versions (i.e. unmatched electronic versions) that not entered into the EHR 120. Consequently, a notification is generated and transmitted for each electronic version 106, including those which correspond to an individual EHR patient having an order for a medical service and those which do not correspond to an individual EHR patient having an order for a medical service. The notifications can be emails sent to the suitable address pertaining to a person or entity entering the electronic versions of the EHR patient records in the EHR. Examples of the matched notifications can indicate the electronic version entered into the EHR. Examples of the unmatched notifications can indicate NO PATIENT MATCH FOUND, indicating that a particular electronic version did not correspond to any EHR patient order; MULTIPLE PATIENT MATCH FOUND indicating that a particular electronic version appears to correspond to an order from more than one EHR patient; and NO ORDER MATCH FOUND indicating that an EHR patient order corresponding to the electronic version could not be found in the EHR. The method ends at 326.

The method illustrated in FIG. 3 may be implemented in a computer program product that may be executed on a computer 108. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use.

The exemplary method 300 may be implemented on one or more general purpose computers 108, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. As will be appreciated, while the steps of the method may all be computer implemented, in some embodiments one or more of the steps may be at least partially performed manually.

It will be appreciated that several of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of entering electronic versions of paper documents into corresponding patient records in an Electronic Health Record (EHR) comprising:
extracting named entity information from electronic versions of patient-related paper documents using natural language parsing performed by a computer processor, the named entity information including patient identifiers and associated patient identity information;
determining EHR patients which correspond to the electronic versions using the patient identifiers, the EHR patients having patient records in the EHR, wherein the determining is performed by a computer processor;
classifying the electronic versions by medical procedure using the named entity information in accordance with a medical taxonomy;
associating order-matching criteria with the electronic versions in accordance with the classifying;
querying the EHR to obtain orders of medical services for the EHR patients;
establishing matched electronic versions which correspond to EHR patient orders by comparing one or more orders obtained from the querying with the order-matching criteria;
entering the matched electronic versions into the EHR by forming an association in the EHR between the matched electronic versions and the EHR patients having at least one order matched in the matching operation; and
generating notifications indicating at least one of the electronic versions entered into the EHR and the electronic versions not entered into the EHR.

2. The method of claim 1 wherein the electronic versions not entered into the EHR include unmatched electronic versions that are not the matched electronic versions.

3. The method of claim 2 wherein the unmatched electronic versions include electronic versions having multiple EHR patients determined in the determining step.

4. The method of claim 2 wherein the unmatched electronic versions include electronic versions having corresponding EHR patients with no orders in the EHR.

5. The method of claim 1 wherein the orders are unfulfilled orders.

6. The method of claim 1 further comprising obtaining the electronic versions from a bulk scan of the paper documents.

7. The patient identifiers include at least one of patent name and patient id number and alpha-numeric patient id.

8. The method of claim 7 wherein the determining EHR patients includes determining one or more of the electronic versions which correspond to a plurality of EHR patients using the patient identifiers, the method further comprising:
minimizing the number of EHR patients having highest correspondence with the electronic versions by comparing the associated patient identity information with patient information in the EHR patient records.

9. The method of claim 1 wherein the extracting named entity information includes using Optical Character Recognition to convert scanned electronic versions into text.

10. The method of claim 1 wherein the order matching criteria includes time information for when the medical procedure was performed.

11. The method of claim 1 wherein the order matching criteria includes the originating source information for the source of the order, the originating source information including at least one of a person's name, an organization's name, an address, a provider's name, and contact information of the originating source.

11. The method of claim 1 wherein the medical procedure includes at least one of a medical diagnosis, laboratory procedure, a preventative procedure and a surgical procedure.

12. The method of claim 1 wherein the generating notifications includes generating notifications indicating errant conditions that occur in the establishing step, wherein the errant conditions include at least one of NO PATIENT MATCH FOUND, MULTIPLE PATIENT MATCH FOUND and NO ORDER MATCH FOUND, wherein the generating the notifications is performed by a processor.

13. The method of claim 1 wherein the generating notifications includes generating email notifications and sending the email notifications.

14. The method of claim 1 further comprising:
delineating transitions between different patient-related paper documents using separating indicia;
performing a bulk scan of the patient-related paper documents to form the electronic versions; and
saving the bulk scan.

15. The method of claim 13 further comprising:
transmitting the bulk scan to a computer processor.

16. A system for entering electronic versions of paper documents into corresponding patient records in an Electronic Health Record (EHR) comprising:
a natural language parsing component which extracts named entity information from electronic versions of patient-related paper documents and determines patient identifiers and associated patient identity information in the electronic versions using the named entity information and determines EHR patients which correspond to the electronic versions using the patient identifiers, the EHR patients having patient records in the EHR;
a classification component which classifies the electronic versions by medical procedure and associates order-matching criteria with the electronic versions in accordance with the classifying;
a communication component for querying the EHR for orders of medical services for the EHR patients;
a matching component which establishes matched electronic versions that correspond to EHR patient orders by comparing one or more orders obtained from the querying with the order-matching criteria;
an association component which enters the matched electronic versions into the EHR by forming an association in the EHR between the matched electronic versions and the EHR patients having at least one order matched in the matching operation;
a notification component which generates notifications indicating at least one of the electronic versions entered into the EHR and the electronic versions not entered into the EHR; and
one or more processors which implement the natural language parsing component, the classification component, the communication component, the association component, and the notification component.

17. The system of claim 16 wherein the natural language parsing component determines one or more of the electronic versions which correspond to a plurality of EHR patients using the patient identifiers and the natural language parsing component minimizes the number of EHR patients having highest correspondence with the electronic versions by comparing the associated patient identity information with patient information in the EHR patient records.

18. The system of claim 16 wherein the electronic versions not entered into the EHR include unmatched electronic versions that are not the matched electronic versions, the unmatched electronic versions including at least one of electronic versions which correspond to multiple EHR patients, electronic versions which correspond to EHR patients with no orders in the EHR, and electronic versions which do not correspond to EHR patients.

19. The system of claim 16 wherein the notification component which generates email notifications.

20. The system of claim 19 wherein the email notifications indicate errant conditions including at least one of NO PATIENT MATCH FOUND, MULTIPLE PATIENT MATCH FOUND and NO ORDER MATCH FOUND.
